(19) United States
(12) Patent Application Publication
(10) Pub. No.: US 2020/0134748 A1
(43) Pub. Date: Apr. 30, 2020

(54) RESIDENTIAL REAL ESTATE LAYOUT DATA COLLECTION, SEARCH, RATING AND RANKING SYSTEM AND METHOD

(71) Applicant: ATTRIBUILD PTE LTD, Singapore (SG)

(72) Inventor: Wai Leong Koon, Singapore (SG)

(21) Appl. No.: 16/624,891

(22) PCT Filed: Jun. 20, 2018
(86) PCT No.: PCT/SG2018/050303

§ 371 Date: Dec. 19, 2019

(30) Foreign Application Priority Data
Jun. 20, 2017 (SG) 10201705098Q

(51) Int. Cl. G06Q 50/16; G06F 16/26; G06F 16/2457; G06F 16/28; G06N 20/00

(52) U.S. Cl. CPC G06Q 50/16; G06F 16/26; G06N 20/00; G06F 16/285; G06F 16/24578

(57) ABSTRACT

A system and method for collecting, evaluating and ranking residential real estate property layout design data for prospective home buyers and tenants based on the floor plan and a dimension attribute of the unit. The system extracts empirical data relating to individual spaces for generation of scores for the empirical data and individual space of the property based on anthropometric studies and an overall score of the property is generated based on the weighted combination of the scores of the individual spaces. Machine learning is utilised to improve the evaluation algorithm for assigning of scores. A report is generated for an evaluated property with the scores, comments on merits and weakness of the layout of the property and the ranking of the property against similar evaluated properties.

### FIELD OF THE INVENTION

The present invention generally relates to an online portal or website of a global computer network such as the Internet and, more particularly, to an online portal for collecting, viewing, organizing, and sharing information relating to the analysis and comparing of residential real estate property based on inputs by a user.

### BACKGROUND OF THE INVENTION

Detailed product specification is generally readily available for durable goods of value such as household appliances, consumer electronics, furniture, tools and vehicles. The product specification provides measurable product attributes that consumers rely upon to objectively compare and rate similar goods of interest.

In contrast, if we consider residential real estate property as a product, the amount of quantifiable and objective specifications and data relating to individual residential real estate property is typically limited to the total floor size, number of bedrooms and bathrooms. Most consumers use this limited descriptions and specifications to make their real estate decisions. Other information available to consumers involves locational context, tenure of deeds and pricing history which are not itself a description nor specification of the residential real estate layout design. For most consumers, residential real estate property is the most significant investment of a household, it requires a high level of involvement, complex decision-making and the long-term commitment of resources. Most prospective home buyers and tenants would want to learn as much as possible about a newly constructed or existing home in order to minimize unpleasant surprises, unexpected difficulties and to ultimately make an informed purchase and rental decision. Without detailed and objective descriptions and specification of the residential real estate layout design, this is not possible.

Home buyers and tenants are influenced by a variety of objective and subjective factors that contribute to the perceived quality of the layout design of the property. Since no two properties are exactly alike, home buyers and tenants still find it generally difficult, if not impossible, to consistently and objectively compare one property to other properties. In particular, home buyers and tenants are typically not well-equipped to analyse and compare property based on the layout design (as represented by floorplan).

Many internet sites have been developed where home buyers and tenants can search residential real estate property listings for available residential properties in the market. While these websites make it easier and more convenient for users to review large selection of residential real estate property listings, they do not contain data or detailed description and specifications of the properties' layout design (as represented by floorplan) and do not allow home buyers and tenants to evaluate, rate, rank, compare residential real estate property based on the analysis of layout designs (as represented by floorplans).

A good layout design (as represented by floorplan) is the foundation of an efficient, logical, suitable and comfortable home. It is also essential that home buyers and tenants know whether a particular real estate property has a good layout design as such property represents the best return on investment since they will not be buying or renting space areas that cannot be efficiently utilised. Space analysis of individual spaces such as living room space, bedroom space can help the prospective home buyer determine the spatial efficiency of the layout design, whether the property meets the lifestyle needs of the household and whether the size and proportion of the living spaces have been designed for comfortable living. However, a typical home buyer does not have the expertise and data to meaningfully analyse the merits of a layout design (as represented by floorplan). Accordingly, there is a need for a system and method for collecting, viewing, analysing, comparing and sharing data and information relating to layout design (as represented by floorplan) of residential real estate property for prospective home buyers and tenants.

### SUMMARY OF THE INVENTION

A system and method in accordance with the present invention includes a residential real estate property layout design (as represented by floorplan) data collection and evaluation system with functionality that makes use of layout design (as represented by floorplan) to generate residential real estate property evaluation related information or perform residential real estate property evaluation related functions. This modular functionality may be B2B, B2C, or C2C oriented, as examples, depending on the configuration of the system.

Preferably, a system in accordance with the present invention is a network-based system, or at least includes an interface to allow access to the various functionality described herein by network enabled devices. As a network-based system, access need not be open public access, but rather could be selectively restricted to those individuals or organizations having memberships with a corresponding service provider or to those willing to purchase access to such functionality in various other manners, such as on a transaction basis.

A system in accordance with the present invention may be configured for access by any of a number of network enabled devices (or “client devices”). A client device may be any electronic device that is enabled to accomplish or take part in transactions via a network. For example, the client device may be a personal computer (PC), such as a workstation, desktop or laptop system, or a server. The client device may also be any of a variety of other devices, such as a personal digital assistant (PDA), e-mail device, telephone, cellular telephone, or networked enabled television or appliance, as examples. Further, a system in accordance with the present invention may be accessible over any of a variety of networks, such as the Internet, World Wide Web (the “Web”), intranets, extranets, local area networks (LANs), wide area networks (WANs), private networks, virtual private networks (VPNs), and so forth, or any combination thereof.

According to the present invention, there is a system for collecting, evaluating and ranking residential real estate property layout design data for prospective home buyers and tenants based on the floor plan and a dimension attribute of the unit, said system comprising:
Means for defining separate individual spaces and total space of a residential real estate property based on a digital floor plan representation
Means for extracting empirical data relating to individual spaces from the digital floor plan representation and a dimension attribute of the unit
Means for generating a score for each empirical data by processing the extracted empirical data
Means for generating a subscore for each individual type of space of the property by processing the generated score for each empirical data point
Means for generating an overall score for the property based on the weighted combination of the scores of all the individual type of spaces.

The system may include means for user input of relevant residential real estate property information including digital floor plan representation and a dimension attribute of the unit.

The dimension attribute of the unit may be the total floor space for ease of generating empirical data relating to individual spaces.

In a preferred embodiment, the empirical data relating to the spaces of the residential real estate property that are evaluated including but not limited to the total area of the unit, proportion of usable space, the dimension and areas of the master bedroom, bedrooms, dining/kitchen, utility area, external area, circulation and other areas.

The system whereby the means for generating scores of empirical data and individual spaces is an algorithm based on anthropometric studies and data analytics for evaluation and rating of a residential real estate property.

The system whereby machine learning provides improved evaluation and rating results with increased number of evaluated units stored in the data storage means.

The system whereby the algorithm is adapted to generate customised scores based on user preference of specific individual empirical physical attributes of the layout of the property.

The system further including means to automatically generate a summary of comments relating to the positive and negative aspects of the unit based on individual empirical physical attributes of the layout of the property.

Preferably the system includes graphical representations or visualizations of the score of individual spaces and the overall score of the residential real estate property.

The system additionally includes storage means for organised storage of information of evaluated units including the digital floor plan representation and extracted empirical data and scores.

The system additionally includes means for ranking a property against other evaluated units in the data storage means based on the overall score of each residential real estate property. The ranking may be represented in numerical value or by graphical representations or visualizations.

The ranking means may display ranking results restricted according to the residential real estate property characteristics, including but not limited to development, date of completion, location, price range.

A method of collecting residential real estate property layout design and evaluating residential real estate property layout design, the method including the steps of:
Receiving a digital floor plan representation and a dimension attribute of a residential real estate property
Defining separate individual spaces and total space of the residential real estate property based on the digital floor plan representation
Extracting empirical data relating to individual spaces from the digital floor plan representation and dimension attribute of the property
Generating a score for each empirical data by processing the extracted data
Generating a subscore for each individual type of spaces by processing the score for each empirical data point,
Generating an overall score for the property based on the weighted combination of the scores of all the individual spaces

A method of collecting residential real estate property layout design and evaluating residential real estate property layout design, further including data analytics to refine the scoring of each empirical data and individual spaces.

### BRIEF DESCRIPTION OF THE DRAWINGS

These and further features of the present invention will be apparent with reference to the following description and drawings, wherein:

FIG. 1 is a diagrammatic view of a system and method of evaluating, ranking and displaying of information relating to real property according to a preferred embodiment of the present invention;

FIG. 2 is a diagrammatic view of the information input page of an online portal of the system of FIG. 1;

FIG. 3 is a diagrammatic view of the empirical data extraction and collection module of the system of FIG. 1;

FIG. 4 is a diagrammatic view of a floor plan evaluation report displayed on the online portal of the system of FIG. 1

FIG. 5 is a self-learning mechanism for refining of scoring of a particular property attribute

FIG. 6 shows part of the matrix for auto generation of comments of the report

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved system and method disclosed herein. The following detailed discussion of various alternative and preferred embodiments will illustrate the general principles of the invention with reference to preferred embodiments. Other embodiments suitable for other applications and within the scope of the present invention will be apparent to those skilled in the art given the benefit of this disclosure.

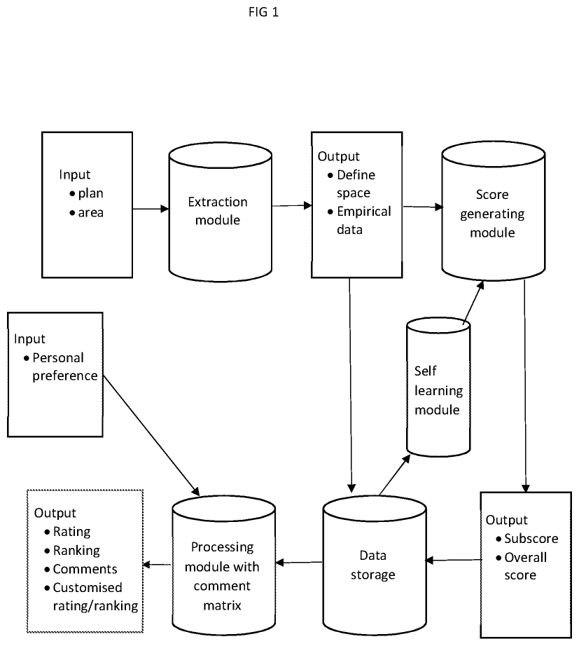

Referring now to the drawings, FIG. 1 schematically shows a system for collecting, evaluating, ranking, and displaying data and information relating to residential real estate property based on its layout design (as represented by floorplan) according to the present invention. The system includes a web based portal for user input of information including floor plan and total unit area required to perform evaluation of the layout design of a real estate property. The submitted information is passed on to a back-end extraction module that extracts dimensional and area data of the unit which is processed through an algorithm that generates scores for specific physical attributes of the unit. The generated scores and extracted raw dimensional and area data of the unit are stored in a data storage module that is used by the machine self-learning mechanism of the score generating module to refine its scoring algorithm. A processing module generates a formal floor plan evaluation report based on the property unit's data stored in the data storage module.

Users can register to establish an account at the website to assess restricted functions of the system as further described hereinafter. Registered or member users access the website via the Internet or the like through personal computers or the like to submit personal information such as preferences and requirements so that a customised and personalised result can be generated by the system. Similar to browsing users, they can upload relevant details of properties of interest for the purpose of evaluation, search and view existing evaluations reports of residential real estate property.

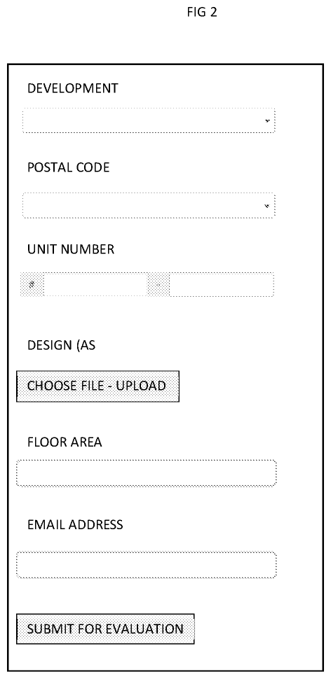

FIG. 2 shows a layout design evaluation upload page of the online portal. The page has various input fields to guide to the user to provide required information about the property which is of interest to the user. Specific information such as development and postal code may be selected from a list of preloaded data and other information such as unit number and floor area is manually input by the user. Once the development and unit number is entered, the system checks whether the property of interest has already been evaluated by system, prompts the user accordingly and directs the user to the relevant layout design evaluation report. If the property of interest has not yet been evaluated by the system, the system will allow the user to proceed with the upload of the corresponding floor plan of the property of interest, input the rest of the required information and submit the information for the system to perform an evaluation.

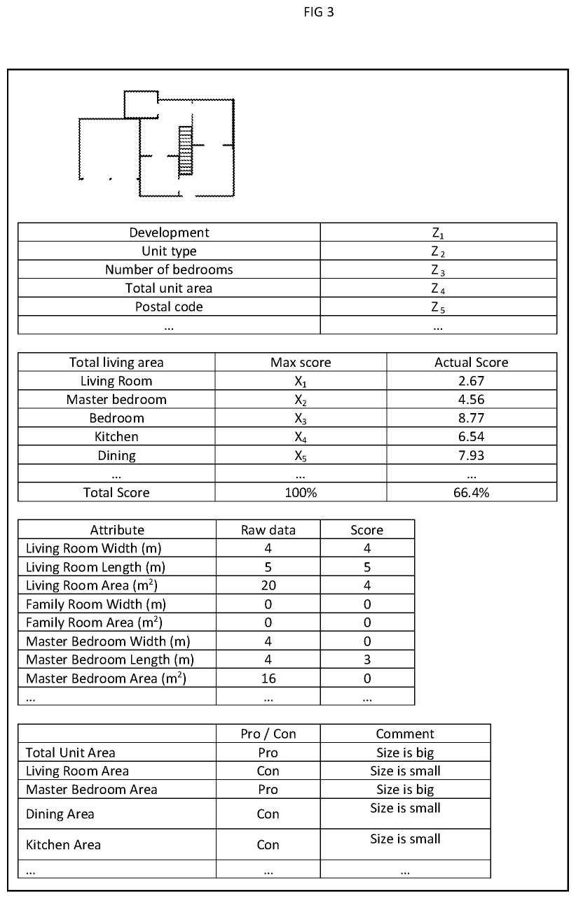

FIG. 3 shows a back-end data extraction tool for the purpose of extracting, organising and saving the dimensional and area data of a floor plan so that they can be processed by an algorithm to generate scores and ratings. The overall outline of the floor plan is defined, which together with the total area of the unit, is used to generate the appropriate drawing scale with which to measure the other dimensions of the property. The individual spaces, including but not limited to living room, bedroom, kitchen, dining area spaces, utility spaces, circulation spaces, external spaces and other spaces are defined and marked on the floorplan. The particular property with its scaled dimensions and areas will then be automatically recorded and saved in a database and fed to the algorithm to generate the scores and ratings. General information such as the number of bedrooms, total unit area, postal code, development is shown at the start of the page, followed by the summary of scores for individual spaces and the overall score of the unit, the scores for each particular attribute and the comments for each individual space. The image of the floor plan with its respective individual spaces defined is also saved and recorded in the database for use as presentation tool for the layout design evaluation report.

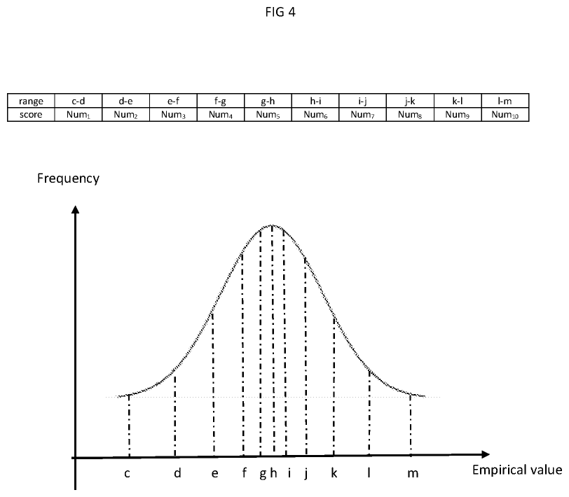

The algorithm used by the system to analyse and rate the empirical physical attributes of residential property is based on a data analytic system to determine the scores for specific physical attributes. The overall database in the system is analysed and the ranges for different scores are determined and assigned to the different physical attributes based on the distribution of the individual data points, coupled with basic anthropometry requirements. For example, the raw data of a particular attribute is plotted in a frequency distribution curve as shown in FIG. 4. A series of values (c-m) is automatically adjusted to segment the total number of raw data points into equal divisions. A score Num₁ is assigned to a specific range of empirical values c-d for a particular attribute as listed in FIG. 3 such as living room width, and successive ranges of empirical values are assigned with a corresponding score as shown in the table of FIG. 4. As such, the scoring process is objective and unbiased. It is achieved based on to the overall data set available for the particular attribute.

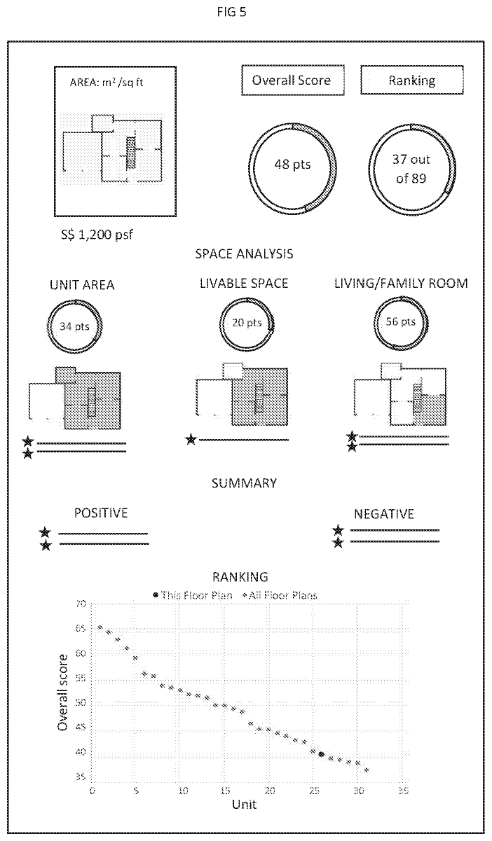

FIG. 5 illustrates a layout design evaluation report of a property that has been evaluated by the system. The overview section displays the property floor plan, an overall score of the layout design (as represented by floorplan) and the ranking of the property amongst all evaluated property units with the same number of bedrooms together with graphical representations of the score and ranking. A high overall score indicates that the unit is well-designed and has provided spaces and rooms that are useful, sufficient and efficient. Sufficient utility spaces like bathrooms, stores and yards can contribute to a high score. A low score on the other hand indicates that the unit may have spaces and rooms that are very inefficient or smaller than ideal. A low score may also assigned when there is a high proportion of spaces with low utility such as bay windows, corridors in the layout design. The report includes information of the property including the number of bedrooms, the total floor area and unit number when the property is an apartment unit in a building.

Where available, pricing information of the unit is also displayed. The pricing information may be displayed as price per unit area of the property. (e.g. $1200/sqft). In addition, based on the identity of the evaluated unit, the average recent transaction prices of the unit and the prices of similar units extracted from data provided by the local real estate authorities, an average recent transacted prices of this property type may be calculated and displayed.

The second portion of the report includes a thorough space analysis of the property by displaying evaluation scores for each individual space of the property including but not limited to unit area, usable space proportion, living/family room, master bedroom, other bedrooms, dining area, kitchen, utility area, external area, circulation and other areas in conjunction with a graphical representation of the score. For ease of reference, each individual space labeled and marked out in color against the complete floor plan against its evaluation score. Supporting comments relating to the merits and weakness of each individual space, the estimated floor area and a recommended furniture configuration suitable for the space is provided for clearer understanding of the usability of the space. The commentaries are automatically generated by the system using a detailed matrix of the scores of the individual empirical physical attributes of the layout of the property.

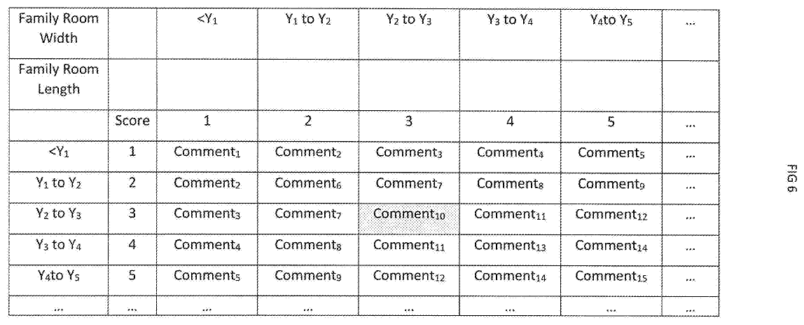

FIG. 6 shows a matrix for comments based on scores of the length and width of a family room. The comment may include mention of the suitability of the length or width of the family room, the type of furniture that can fit the space of the family room, its suitability for alternative uses. Based on the matrix in FIG. 6, for a family room that has a score of 3 for length and 3 for width, Comment₁₀ will be displayed in the evaluation report.

The term usable space proportion refers to the percentage of the living/family room, kitchen, dining area and bedrooms space area over the unit area. Utility area includes storage area, bomb shelters, bathrooms, proportion of bathrooms to bedrooms. External area includes balcony, roof terraces planter boxes and external patios. Circulation refers to corridors, stairs, lift lobbies, etc. Other areas include the air conditioning ledge, bay windows, private carparks, strata voids, etc.

The next section of the layout design evaluation report of FIG. 5 is a summary of the main positive and negative aspects of the residential real estate property based on its layout design (as represented by floorplan) for user consideration. The summary is automatically generated by the system using a detailed matrix of the scores of the individual empirical physical attributes of the layout of the property, similar to the matrix shown in FIG. 6.

The final section is an interactive graphical representation of the ranking of the particular property against all evaluated property with the same number of bedrooms is displayed at the end of the report. Each dot in the chart represents a particular residential real estate property. When the cursor rests over a particular dot, basic information including the name of the development, postal code, unit number and overall score of the corresponding residential real estate property is displayed. The user may filter the number of properties displayed in the graphical representation using various criteria such as locations of interest, price points, price per unit area and completion date of the property. By clicking on the dot, the user is redirected to the full floor plan report of the selected property. With this feature, the user can quickly access layout design evaluation reports across similar properties.

At the top of the report page, links are provided to bring the user to the start of each section, namely the overview, space analysis, summary and ranking sections of the report.

The algorithm used by the system to analyse and rate the empirical physical attributes of residential property includes a machine self-learning mechanism. As explained earlier with reference to FIG. 4, it uses data analytic to determine the scores to be attached to certain physical attributes, therefore, it is leveraged to provide floor plan evaluation with increased relevancy as the number of evaluation performed increases. As more property is evaluated and more data relating to living room width is collected, the frequency distribution will change and the empirical values that correspond to each equal segment (c-m) will be changed to reflect a new distribution of the raw data points. Therefore, the scores assigned to a specific empirical value will be continuously adjusted with more evaluated properties in the database in order to reflect a more accurate rating of any specific unit.

The self-learning mechanism permits feedback from scores from similar evaluated property, for example property having the same number of bedrooms to be accepted to facilitate in optimizing property evaluation. For example, if the system evaluates a property located in a highly densely populated city where generally property unit sizes are smaller, the scores relating to the total size of the property and sizes of individual spaces assigned to the property will be higher than the corresponding scores of a property with identical floor plan located in a suburban region of low housing density where generally property unit sizes are larger. The self-learning mechanism hence allows the system to be independently deployed in different markets and be viable as long as the number of evaluations reaches critical mass.

As the number of evaluated property increases in system database, users are able to search property based on the user's preferred overall floor plan evaluation score. The user may further filter the results by selecting various criteria such as preferred locations, price and completion date of the property.

The floor plan evaluation reports are organised by location/district and development. Users are able to browse floor plan evaluation reports by selecting a particular district of interest, the name of the development project and selecting a particular floor plan.

An interactive map that displays icons representing developments where floor plan evaluation reports are available may be accessed by the user, the user selects the icon based on its location on the map and a list of floor plans associated with the selected property development is displayed. The floor plan evaluation report is displayed by clicking on the floor plan.

It is apparent from the above detailed description of preferred embodiments of the present invention, that the system and method of the present invention enables prospective home buyers and tenants to search, view, analyse, compare and share information relating to layout design (as represented by floorplan) of residential real estate property. By comparing the scores calculated by the present invention which relate to the livability of a unit against the price per unit area that is also displayed in the report, prospective home buyers and tenants can determine if the cost of the property is value for money in terms of its spatial provision. The form of data analysis as described in the preferred embodiment similarly should not be taken to be restricted to machine learning and can include both supervised or unsupervised learning mechanism. It is also apparent that this system can be a complementary feature to existing residential real estate property listing websites.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

1. A system for collecting, evaluating and ranking residential real estate property layout design data based on the floor plan and total floor space of the unit, said system comprising:
means for defining separate individual spaces and total space of a residential real estate property based on a digital floor plan representation;
means for extracting empirical data relating to individual spaces from the digital floor plan representation and total floor space area;
means for generating a score for each empirical data by processing the extracted empirical data;
means for generating a subscore for each individual type of space of the property by processing the generated score for each empirical data point;
means for generating an overall score for the property based on the weighted combination of the scores of all the individual type of spaces; and
data storage means for storing the extracted data and generated scores, subscores and overall score of the property

2. The system of claim 1 further comprising means for user input of relevant residential real estate property information including digital floor plan representation and total floor space area.

3. The system of claim 1 wherein the empirical data relating to the spaces of the residential real estate property that are evaluated including the total area of the unit, proportion of usable space, the dimension and areas of the master bedroom, bedrooms, dining/kitchen, utility area, external area and circulation.

4. The system of claim 3 wherein the means for generating scores of empirical data and subscores of individual spaces is an algorithm based on anthropometric studies and big data analytics for evaluation and rating of the provision of spaces of a residential real estate property.

5. The system of claim 4 whereby machine learning provides improved evaluation and rating results with increased number of similar evaluated units stored in the data storage means.

6. The system of claim 4 whereby the algorithm is adapted to generate customised scores based on user input of preference of specific individual empirical physical attributes of the layout of the property.

7. The system of claim 1 comprising means to automatically generate a summary of comments relating to the positive and negative aspects of the unit based on individual empirical physical attributes of the layout of the property.

8. The system of claim 1 comprising means for ranking a property against other evaluated units in the data storage means based on the overall score of each residential real estate property.

9. A method of collecting residential real estate property layout design and evaluating residential real estate property layout design, the method including the steps of:
receiving a digital floor plan representation and the associated total floor area of a residential real estate property;
defining separate individual spaces and total space of the residential real estate property based on the digital floor plan representation;
extracting empirical data relating to individual spaces from the digital floor plan representation and total floor space area;
generating a score for each empirical data by processing the extracted data;
generating a subscore for each individual type of spaces by processing the score for each empirical data point; and
generating an overall score for the property based on the weighted combination of the scores of all the individual spaces.

10. A method of collecting residential real estate property layout design and evaluating residential real estate property layout design according to claim 9 further including data analytics to refine the scoring of each empirical data and individual spaces.

11. A method of collecting residential real estate property layout design and evaluating residential real estate property layout design according to claim 10 further including ranking of the evaluated property against other similarly evaluated properties.
